(19) United States
(12) Patent Application Publication
(10) Pub. No.: US 2026/0170335 A1
(43) Pub. Date: Jun. 18, 2026

(54) DEVICES AND METHODS FOR DISTRIBUTED ADAPTIVE LEARNING IN WIRELESS SYSTEMS

(71) Applicant: HUAWEI TECHNOLOGIES CO., LTD., Shenzhen (CN)

(72) Inventors: Miguel Angel GUTIERREZ ESTEVEZ, Munich (DE); Ramin Khalili, Munich (DE); Ramya PANTHANGI MANJUNATH, Munich (DE); Jose Mauricio Perdomo, Munich (DE)

(73) Assignee: HUAWEI TECHNOLOGIES CO., LTD., Shenzhen (CN)

(21) Appl. No.: 19/532,919

(22) Filed: Feb. 6, 2026

Related U.S. Application Data
(63) Continuation of application No. PCT/EP2023/071901, filed on Aug. 8, 2023.

(51) Int. Cl. G06N 3/08; G06N 3/0455

(52) U.S. Cl. CPC G06N 3/08; G06N 3/0455

(57) ABSTRACT

An agent entity for adaptive learning is disclosed. The agent entity is configured to operate a machine learning, ML, model, wherein the ML model is configured to process input data into output data with a selectable computational complexity and with a selectable size of the output data. Moreover, the agent entity is configured to estimate computational resources of the agent entity and obtain information indicative of the selectable size of the output data of the ML model. The agent entity is configured to select the computational complexity and/or the size of the output data of the ML model based on the estimate of the computational resources of the agent entity and/or the information indicative of the selectable size of the output data of the ML model.

### CROSS-REFERENCE TO RELATED APPLICATIONS

This application is a continuation of International Application No. PCT/EP2023/071901, filed on Aug. 8, 2023, the disclosure of which is hereby incorporated by reference in its entirety.

### TECHNICAL FIELD

Embodiments of the present disclosure relate to wireless communications. More specifically, embodiments of the present disclosure relate to devices and methods for distributed adaptive learning in wireless communication systems.

### BACKGROUND

Artificial intelligence (AI) and machine learning (ML) are being studied for use cases that require cooperation among existing and new network nodes in 3GPP wireless communications systems, such as cooperation between user equipments (UEs) and base stations (BS) and cooperative drones or mobile robots with sensing capabilities. For instance, mobile robots with sensing capabilities as a network node are being studied in 3GPP in use cases including but not limited to factories, e-health, smart cities and hazardous environments to support sensing and communication of machines. Such network nodes may be powered by AI/ML, and usually require a wireless link to a central node (controller) for coordination.

During training and interference distributed AI/ML schemes, such as Split Learning (SL) or Federated Learning (FL), often operate in a dynamic and unreliable wireless environment together with time-varying states of the network nodes. For adapting distributed AI/ML schemes to dynamic wireless environments it has been proposed to store and manage several ML models (each one with different compression and complexity capabilities) so that the system needs to select, load and deploy the suitable ML model when the wireless environment is changing. This is neither practical nor scalable in very dynamic wireless environments.

### SUMMARY

The present disclosure provides improved devices and methods for distributed adaptive learning in wireless communication systems.

According to a first aspect, an agent entity for adaptive learning is provided. The agent entity is configured to operate a machine learning, ML, model for adaptive learning, wherein the ML model is configured to process input data into output data with a selectable, i.e. adjustable computational complexity and with a selectable, i.e. adjustable size of the output data. Moreover, the agent entity is configured to estimate current computational resources of the agent entity for operating the ML model and to obtain information indicative of the selectable size of the output data of the ML model. The agent entity is further configured to select the computational complexity and/or the size of the output data of the ML model based on the estimate of the current computational resources of the agent entity and/or the information indicative of the selectable size of the output data of the ML model.

Thus, the agent entity according to the first aspect allows adapting its ML model according to its computational capabilities (and possibly further communication resource capabilities) in wireless communication systems where collaboration between agent entities is necessary and the ML models are spread across several agent entities. For instance, the agent entity according to the first aspect may adapt to limited and time-varying wireless resources together with time-varying wireless channels between the cooperating network nodes in the distributed ML model task. These changes can occur in a significantly fast manner, e.g., as fast as the time coherence of wireless channels. Moreover, the agent entity according to the first aspect may adapt to time-varying computational capabilities caused, for instance, by the contention among other different tasks running on the agent entity. Operating the ML model with a desired target accuracy may involve significant amount of computation for resource-constrained agent entities, such as mobile devices, UAVs, mobile robots and the like, which may directly impact their power consumption. If the distributed ML model is left unadapted, changes in the system may negatively affect the network performance or the correct operation of the cooperative network nodes involved in the distributed ML model task. Moreover, wireless resources may be dynamically used in a shared channel among a plurality of agent entities so that more communication resources may be allocated to those agent entities experiencing a degraded wireless channel. This may be used, for instance, for dynamic resource assignment for a control channel over which channel state information is reported.

In a further possible implementation form, the agent entity is configured to receive the information indicative of the selectable size of the output data of the ML model from a controller entity via a wireless communication channel. This allows for a centralized control of the selectable size of the output data of the ML model of a plurality of agent entities by the controller entity.

In a further possible implementation form, for obtaining the information indicative of the selectable size of the output data of the ML model the agent entity is configured to estimate current communication resources for communicating via a wireless communication channel with a controller entity, wherein the agent entity is configured to select the computational complexity and/or the size of the output data of the ML model based on the estimate of the current computational resources and the estimate of the current communication resources. This allows adapting the complexity and/or output data of the ML model of the agent entity based on the current computation and communication capabilities of the agent entity.

In a further possible implementation form, for estimating the current communication resources the agent entity is configured to determine channel state information of the wireless communication channel between the agent entity and the controller entity and the agent entity is configured to select the computational complexity and/or the size of the output data of the ML model based on the estimate of the current computational resources of the agent entity and the channel state information. This allows the agent entity to efficiently estimate the current communication capabilities of the agent entity.

In a further possible implementation form, the agent entity is further configured to send the output data of the ML model via the wireless communication channel to the controller entity. This allows the controller entity to collect and process the output data from a plurality of agent entities.

In a further possible implementation form, in response to sending the output data of the ML model to the controller entity, the agent entity is further configured to receive response data from the controller entity, wherein the response data is based on the output data of the ML model of the agent entity and a plurality of further output data of a plurality of further ML models of a plurality of further agent entities. This allows the agent entity to receive feedback data from the controller entity based on the output data from a plurality of agent entities.

In a further possible implementation form, the response data contains information indicative of an action to be taken by the agent entity and/or information for performing a backward pass for updating the ML model of the agent entity. This allows the agent entity to perform an action and/or adjust its ML model based on the feedback from the controller entity.

In a further possible implementation form, the agent entity is a user equipment configured to exchange data with the controller entity via the wireless communication channel and a base station.

In a further possible implementation form, the ML model is an encoding portion of an autoencoder, wherein the input data of the encoding portion of the autoencoder is the channel state information and the output data of the encoding portion of the autoencoder is compressed channel state information. This allows the agent entity to efficiently compress the channel state information based on the current computational and/or communication resources of the agent entity.

In a further possible implementation form, the agent entity is a mobile micro base station.

In a further possible implementation form, the agent entity is a base station and the controller entity is a user equipment.

In a further possible implementation form, the ML model comprises a plurality of processing layers for processing the input data into the output data and wherein for selecting the computational complexity of the ML model the agent entity is configured to select a selectable number of processing layers of the plurality of processing layers of the ML model. This allows the agent entity to efficiently adjust the computational complexity of the ML model of the agent entity.

In a further possible implementation form, the agent entity comprises a battery for powering one or more processors of the agent entity for implementing the ML model and wherein the agent entity is configured to estimate the current computational resources of the agent entity based on a load status of the battery. This allows the agent entity to efficiently estimate the current computational resources of the agent entity for operating the ML model.

According to a second aspect, a method for operating an agent entity for adaptive learning is provided. The method comprises the steps of: operating a machine learning, ML, model for adaptive learning, wherein the ML model is configured to process input data into output data with a selectable, i.e. adjustable computational complexity and with a selectable, i.e. adjustable size of the output data;
estimating current computational resources of the agent entity for operating the ML model; obtaining information indicative of the selectable size of the output data of the ML model; and selecting the computational complexity and/or the size of the output data of the ML model based on the estimate of the current computational resources of the agent entity and/or the information indicative of the selectable size of the output data of the ML model.

The method according to the second aspect of the present disclosure can be performed by the robot according to the first aspect of the present disclosure. Thus, further features of the method according to the second aspect of the present disclosure result directly from the functionality of the robot according to the first aspect of the present disclosure as well as its different implementation forms described above and below.

According to a third aspect, a computer program product is provided, comprising a computer-readable storage medium for storing a program code which causes a computer or a processor to perform the method according to the second aspect, when the program code is executed by the computer or the processor.

Details of one or more embodiments are set forth in the accompanying drawings and the description below. Other features, objects, and advantages will be apparent from the description, drawings, and claims.

### BRIEF DESCRIPTION OF THE DRAWINGS

In the following, embodiments of the present disclosure are described in more detail with reference to the attached figures and drawings, in which:

FIG. 1 is a schematic diagram illustrating a plurality of agent entities according to an embodiment in communication with a base station and a controller entity for distributed adaptive learning;

FIG. 2 is a table illustrating a plurality of ML model execution policies defined for different conditions of an agent entity according to an embodiment;

FIG. 3 is a signalling diagram illustrating the dynamic adaptation of a ML model of an agent entity according to an embodiment for changing conditions of the agent entity;

FIG. 4 is a signalling diagram illustrating the interaction between a base station controller entity and a UE agent entity according to an embodiment for uplink transmission of compressed downlink channel state information;

FIG. 5 is a signalling diagram illustrating the interaction between a base station agent entity according to an embodiment and a UE controller entity for downlink transmission of compressed uplink channel state information;

FIG. 6 is a signalling diagram illustrating the interaction between a controller entity and a plurality of Micro base station agent entities according to an embodiment for coordination of the plurality of Micro base station agent entities; and

FIG. 7 is a flow diagram illustrating a method for operating an agent entity according to an embodiment for distributed adaptive learning.

In the following, identical reference signs refer to identical or at least functionally equivalent features.

### DETAILED DESCRIPTION OF THE EMBODIMENTS

In the following description, reference is made to the accompanying figures, which form part of the disclosure, and which show, by way of illustration, specific aspects of embodiments of the present disclosure or specific aspects in which embodiments of the present disclosure may be used. It is understood that embodiments of the present disclosure may be used in other aspects and comprise structural or logical changes not depicted in the figures. The following detailed description, therefore, is not to be taken in a limiting sense, and the scope of the present disclosure is defined by the appended claims.

For instance, it is to be understood that a disclosure in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. Moreover, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

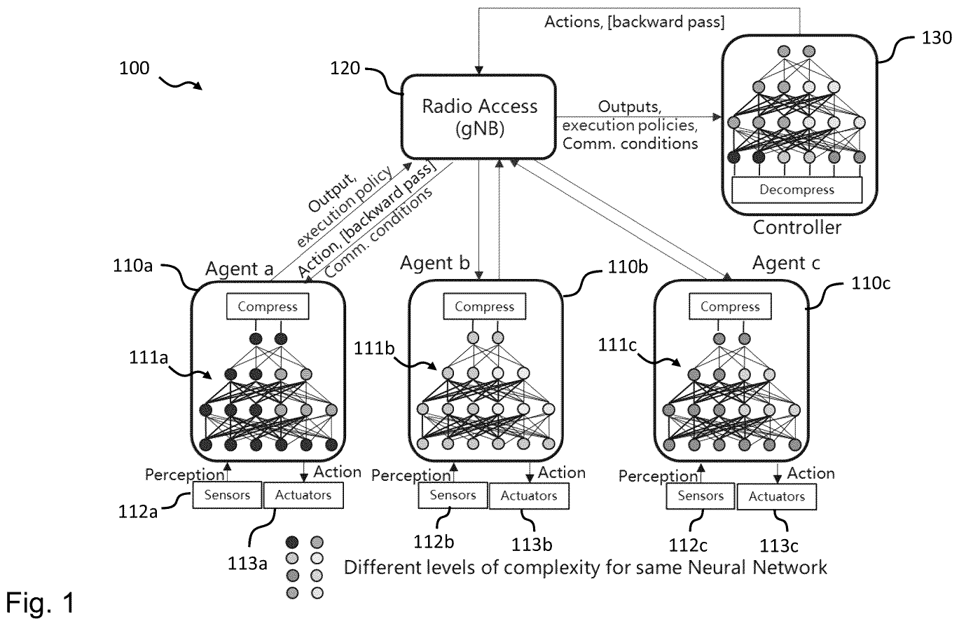

Before describing detailed embodiments in the following some terminology will be introduced making use of one or more of the following abbreviations:
ML Machine Learning
AI Artificial Intelligence
MLOL Machine Learning Orchestrator
LLA Local Learning Agent
FL Federated learning
SL Split Learning
MTLF Model Training Logical Function
AnLF Analytics Logical Function
NWDAF Network Data Analytics Function
UE User Equipment
3GPP 3G Partnership Program
OAM Operations, Administrations and Maintenance
AF Application Function
QoS Quality of Service
NF Network Function
NG-RAN Next Generation RAN
gNB next generation Node B
BS Base Station
NN Neural Network
CNN Convolutional Neural Network
DAG Directed Acyclic Graph
HFL Hierarchical FL
FD Federated Distillation
FFNN Feed-Forward Neural Network
LSTM Long-Short Time Memory
RNN Recurrent Neural Network
RF Random Forrest
EMA Exponential Moving Average
MEC Multi-access Edge Computing
eNA enablers for Network Automation
CSI Channel State Information
AP Access Point
RRC Radio Resource Control
FIG. 1 is a schematic diagram illustrating a plurality of agent entities 110a-n according to an embodiment in communication with a base station 120 and a controller entity 130 in a wireless communication network 100, for instance, a 5G network 100. As used herein, an agent entity is part of a group of agent entities 110a-n, wherein each agent entity 110a-n may be configured collect input information, for instance, from sensors 112a-c or from channel measurements, process and compress the information with a learnable function, such as a Machine Learning (ML) model 111a-c, in particular Neural Network (NN) 111a-c, and transmit the processed information over a channel of the wireless communication network 100 to the base station 120 (herein also referred to as access point 120), such as a gNB 120. Each agent entity 110a-n may also receive feedback information from the controller entity 130 via the base station 120, such as an action to be taken by an actuator 113a-c of the agent entity 110a-n, or the necessary information to perform a backward pass to update the parameters of the ML model 111a-c implemented by each agent entity 110a-n. Also, the agent entities 110a-n may act based on the action information received from the controller entity 130 via the base station 120 to execute some action from all actions possible by the respective agent entity, 110a-n, such as changing its position. The base station or access point 120 is configured to collect the outputs of the agent entities 110a-n and forward this data to the controller entity 130. Moreover, the base station or access point 120 may receive feedback from the controller entity 130 and forward the feedback to the plurality of agent entities 110a-n. The controller entity 130 is generally configured to process and combine the output of the plurality of ML models 111a-c from the plurality of agent entities 110a-n and to generate feedback for each agent entity 110a-n on the basis thereof. As will be described in more detail below, this feedback may comprise information indicative of an action to be taken by each agent entity 110a-n (for instance by an actuator 113a-c thereof) or a de-compressed version of the output information provided by each agent entity 110a-n. The feedback from the controller entity 130 may be transmitted via the base station 120 back to the agent entities 110a-n possibly together with the information regarding a backward pass if the agent entities 110a-n and the controller entity 130 are operating in a training mode.

In the embodiment shown in FIG. 1, the agent entities 110a-c implementing the ML models 111a-c are UEs 110a-c and the controller entity 130 is a network entity 130 (in a further embodiment the controller entity 130 may be part of the base station 120). Additional embodiments will be described further below, where the agent entities 110a-c and the controller entity 130 are implemented as other types of communication devices, such as mobile robots, drones, micro base stations and the like, for instance, as nodes of a 6G network. Further examples include cooperative drones or mobile robots with sensing and communication capabilities, which are considered as potential enhancements of the network towards 6G. Such nodes may have sensors and actuators, wherein the actuators move and control mechanisms of the robots, e.g. moving them in a specific direction, adjusting their transmission power, and activating/deactivating sensing components.

As already mentioned above, each UE agent entity 110a-c illustrated in FIG. 1 is configured to operate a ML model 111a-c, wherein the ML model 111a-c is configured to process input data into output data with a selectable computational complexity and with a selectable size of the output data.

Each UE agent entity 110a-c illustrated in FIG. 1 is further configured to estimate the current computational resources (also referred to as computational capabilities) of the agent entity 110a-c and to obtain information indicative of the selectable size of the output data of the ML model 111a-c operated by the respective UE agent entity 110a-c.

Moreover, each UE agent entity 110a-c illustrated in FIG. 1 is configured to select the computational complexity and/or the size of the output data of the ML model 111a-c based on the estimate of the computational resources (i.e. computational capabilities) of the respective agent entity 110a-c and/or the information indicative of the selectable size of the output data of the ML model 111a-c.

Thus, according to embodiments disclosed herein the agent entities 110a-c and the controller entity 130 may adapt the level of computation by dynamically adapting the complexity of the ML models 111a-c during run-time. In further embodiments, the agent entities 110a-c may adjust for different levels of communication resources (i.e. communication capabilities) by dynamically adapting the compression of the output of each ML model 111a-c of each agent entity 110a-c. In other words, embodiments disclosed herein allow adapting the learning procedure at runtime to the current communication and computation resources/capabilities.

As illustrated in FIG. 1, in an embodiment, the interaction between the UE agent entities 110a-c of FIG. 1 and the controller entity 130 may be implemented in the following way. For each agent entity 110a-c the smallest ML model 111a-c with regard to complexity and compression level may be fixed. These smallest ML models 111a-c are trained, until the system cannot learn more with the set complexity and compression level. At this stage, the weights of the ML models 111a-c may be fixed or frozen and more neurons or processing layers may be added to the ML models 111a-c for increasing the complexity and reducing compression. These enhanced ML models 111a-c are trained again, until the system cannot learn more with the set complexity and compression level. The previous adjustment and training steps are repeated, until all desired levels of complexity and compression have been trained. At the controller entity 130, the current compression and complexity levels are collected, which may be used for post-processing and decompressing, respectively. During deployment, the agent entities 110a-c communicate the level of complexity and compression to the controller entity 130 via the base station 120.

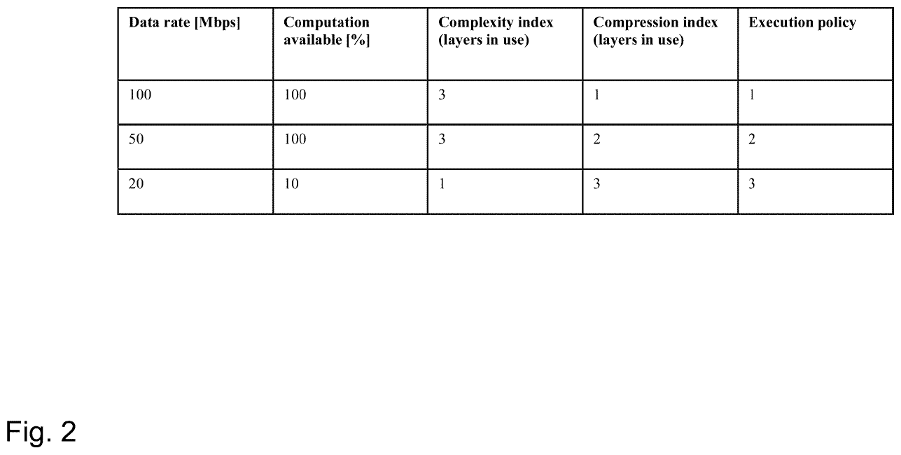

Thus, embodiments disclosed herein may involve one or more of the following features: communication of network conditions by the base station 120 to the agent entities 110a-c and the controller entity 130; mapping from node conditions, such as bps, processing capability, latency, and the like, to an execution policy based on, for instance, the table shown in FIG. 2; communication of the selected execution policy from the agent entities 110a-c to the controller entity 130 via the base station 120; dynamic adaptation of complexity and compression levels of the agent entities 110a-c and the controller entity 130. In an embodiment, the complexity and compression index of the table shown in FIG. 2 may indicate the percentage of all layers of the respective ML model 110a-c in use to induce a certain level of complexity and compression from the ML model 110a-c.

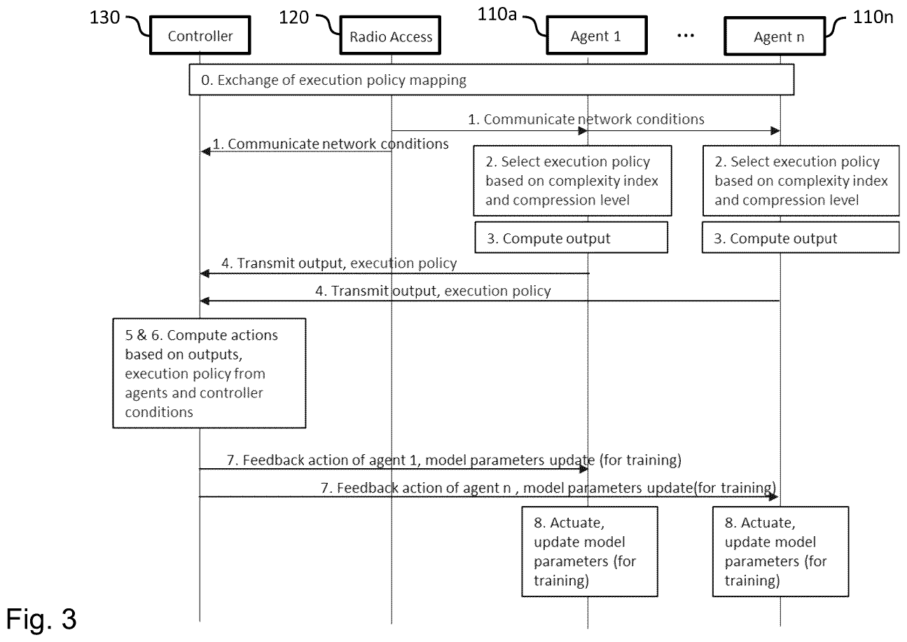

FIG. 3 is a signaling diagram illustrating the dynamic adaptation of the ML model 111a-c of each agent entity 110a-c of FIG. 1.

In a step 0 of FIG. 3, the controller entity 130 and the plurality of UE agent entities 110a-n exchange via the base station 120 an execution policy mapping, for instance, the execution policy table shown in FIG. 2.

In a step 1 of FIG. 3, the base station 120 shares information about the network conditions to the plurality of UE agent entities 110a-n and the controller entity 130.

In step 2 of FIG. 3, each UE agent entity 110a-n selects the ML model execution policy based on the complexity index and the compression level, for instance, based on the table shown in FIG. 2.

In step 3 of FIG. 3, each UE agent entity 110a-n determines the output of the ML model 110a-c in accordance with the execution policy selected in the previous step.

In step 4 of FIG. 3, each UE agent entity 110a-n transmits the output of the ML model 110a-c as well as the execution policy to the controller entity 130.

In steps 5 and 6 of FIG. 3, the controller entity 130 determines the actions for the UE agent entities 110a-n based on the outputs of the ML models 111a-c and the execution policies from the UE agent entities 110a-n and possibly based on further conditions of the controller entity 130.

In step 7 of FIG. 3, the controller entity 130 feedbacks the actions and ML model parameter updates determined in the previous step to the UE agent entities 110a-n.

In step 8 of FIG. 3, each UE agent entity 110a-n may perform an action and update its ML model parameters based on the feedback received from the controller entity 130.

Thus, in an embodiment, each agent entities 110a-n may be configured to perform the following operations:
1. Collect current communication conditions (e.g. bps, latency) and computational capabilities.
2. Look up execution policy pᵢ in mapping table (such as the execution policy table shown in FIG. 2) from complexity index and compression level.
3. Compute output zᵢ from input according to execution policy pᵢ.
4. Transmit output zᵢ and execution policy pᵢ to the controller entity 130 via the base station 120.

In an embodiment, the controller entity 130, in turn, is configured to perform the following operations:
5. Collect all outputs z₁, . . . , zₙ and execution polices p₁, . . . , pₙ from the agent entities 110a-n.
6. Decompress and process all outputs z₁, . . . , zₙ according to the execution policies p₁, . . . , pₙ and generate outputs o₁, . . . , oₙ according to controller conditions and system status. Optionally compute gradients and update controller parameters (if in training).
7. Optionally feedback outputs o₁, . . . , oₙ to the agent entities 110a-n and gradients (if in training).

All agent entities 110a-c receive the output oᵢ from the controller entity 130 and execute accordingly and update the model 111a-c (if in training).

Further embodiments of the agent entity and the controller entity will be described in the following.

A first further embodiment is directed to the compression of channel state information (CSI) for MIMO FDD systems. As will be appreciated, CSI information is used for making transmission parameter decisions, such as selecting a modulation and coding scheme, the number of transmission layers, and the like, necessary for achieving a desired communication system performance. This is done primarily by relying on pilots send from the transmitter to receiver, and the receiver sharing the estimated channel information or relevant channel parameters back to the transmitter. With the growing number of transmit and receive antennas, the CSI feedback information can occupy a substantial amount of uplink bandwidth. In order to cope with the increasing bandwidth demand of sharing CSI feedback, an embodiment disclosed herein allows sharing CSI information derived from reference signals, such as CSI-RS, in an efficient manner by considering communication resource conditions (e.g., data rate, latency, etc.) and computational resource conditions, i.e. capabilities (e.g., processing capability, storage capability) of the involved nodes. Current schemes in 3GPP enable sharing of quantities, such as RI, PMI, CQI, among others, derived from CSI reporting parameters and predefined mechanisms (e.g., existing codebooks).

According to an embodiment each agent entity 110a-n enables compressing the CSI feedback information, for mechanisms that currently exist, and other potential flexible transmission adaptation mechanisms that could rely on raw channel estimate (e.g., channel matrix derived from reference signals). More specifically, each agent entity 110a-n is configured to share and process compressed CSI feedback information by dynamically varying the compression levels depending on the communication resource conditions and the computational resources at the respective node.

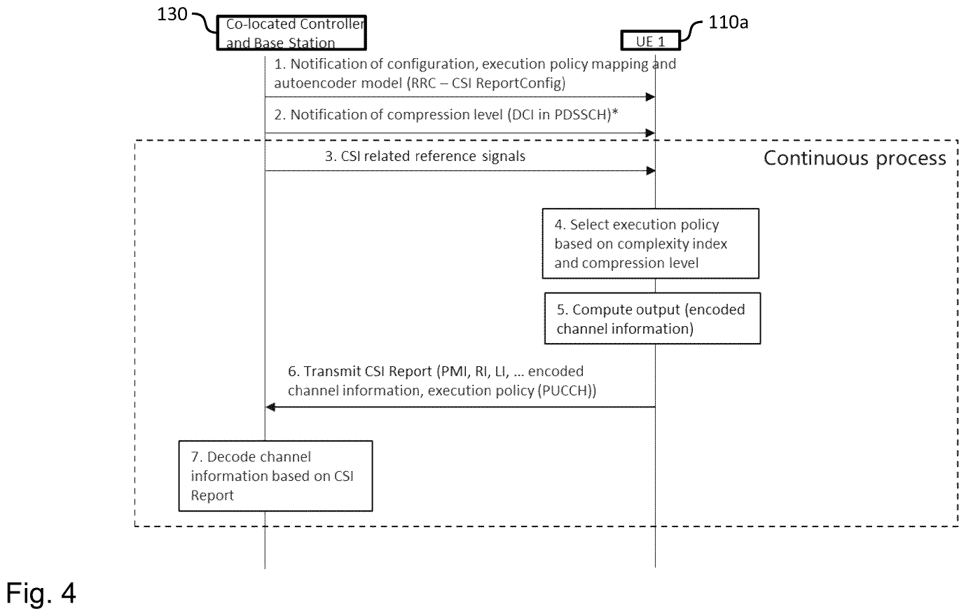

FIG. 4 shows a signaling diagram (comprising the steps 1 to 7 illustrated in FIG. 4) for a first scenario concerning the transmission of compressed downlink CSI in the uplink. In this case, the compressed CSI information is shared from the transmitter which is considered to be the UE agent entity 110a to the receiver which is considered to be the base station 120. This corresponds to the transmission of compressed downlink CSI to enable transmission adaptions at the base station 120. The controller entity 130 is part of the base station 120. As an example, autoencoders are considered to compress and decompress the CSI information at the UE agent entity 110a and the base station 120, respectively. More specifically, the UE agent entity 110a hosts the encoder, which compresses the CSI information and transmits it over the air interface. The base station 120 including the controller entity 130 hosts the decoder, which de-compresses it upon reception, according to the execution policy index used. In this embodiment, an autoencoder model with only one agent entity is assumed to be trained and deployed at the base station 120, 130 and the UE 110a. The compression configuration of the autoencoder may be based on the network conditions at the base station 120, such as the channel quality to all users connected to the base station 120 or the load at the base station 120. Hence the base station 120 may determine and share the compression level with the UE 110a. The base station may be further configured to share the mapping, between communication and computation resources available, and execution policy index

Upon receiving the compression level from the base station 120, the UE 110a based on its computational capability (e.g., depending on battery status) and the shared table determines the complexity level (of compression/decompression process), and hence the execution policy from the shared execution policy table, for instance, the table shown in FIG. 2. The CSI feedback at the UE 110a may be compressed based on this decision. The UE 110a may share the compressed output and the associated execution policy to enable decompression at the base station as part of a CSI report (see step 6 of FIG. 4).

The embodiment descried above may be implemented in current communication systems by enhancing RRC information elements. In an embodiment, the RRC information elements related to CSI such as CSI-ReportConfig could incorporate the following elements:
new id in reportConfigId—for indicating autoencoder based CSI feedback for downlink CSI
new quantities in reportQuantity—compressed downlink CSI, execution policy
new field for CSImodel—for sharing encoder part of the autoencoder based CSI feedback model, for sharing the mapping from communication and computation resource to execution policy
new field for CSImodel parameters—physical location of where to retrieve compression level (i.e, location of physical resource element, e.g., in a field of the DCI of the PDCCH)

The transmission of CSI report from the UE 110a can be carried out in the PUCCH. As already described above, the CSI report may be expanded with the encoded channel information and the execution policy (see step 6 of FIG. 4).

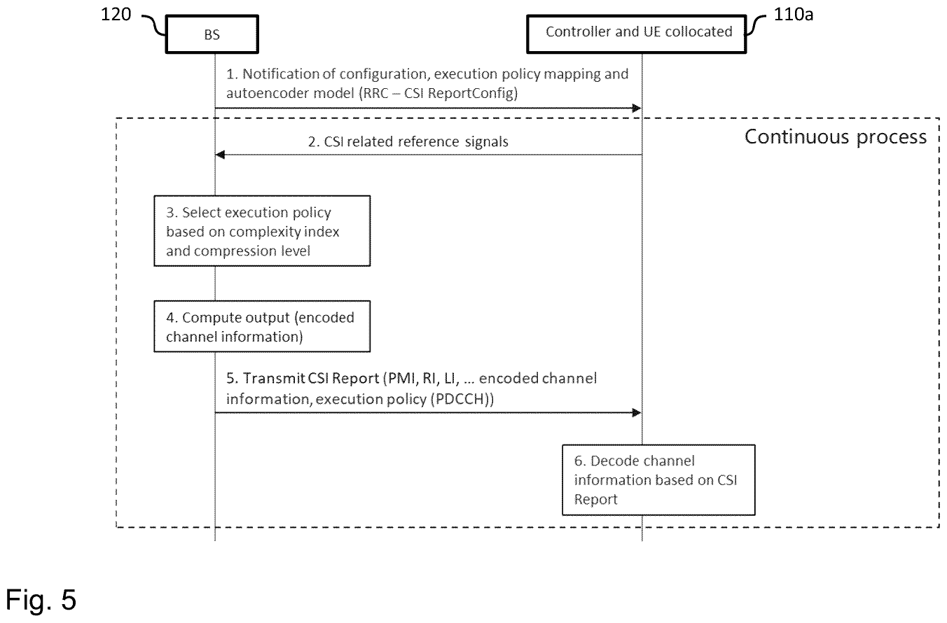

FIG. 5 shows a signaling diagram (comprising the steps 1 to 6 illustrated in FIG. 5) for a second scenario concerning the transmission of compressed uplink CSI in the downlink. In this case, the compressed CSI information is shared from the base station 120 to the UE 110a. This corresponds to the transmission of compressed uplink CSI to enable transmission adaptions at the UE 110a. In this embodiment, the controller entity is part of the UE 110a. Since the base station 120 shares the compressed CSI feedback information, it is aware of the compression level and the computation level to adopt, and hence locally may choose the execution policy, for instance, based on the execution policy table shown in FIG. 2. This execution policy is shared with the UE 110a along with the compressed CSI output (see step 1 of FIG. 5).

Similar to the first scenario described above, this second scenario may be enabled in current communication systems by enhancing RRC information elements. As an example, the RRC information elements related to CSI such as CSI-ReportConfig could incorporate the following elements:
new id in reportConfigId—for indicating autoencoder based CSI feedback for uplink CSI
new quantities in reportQuantity—compressed uplink CSI, execution policy
new field for CSImodel—for sharing the encoder part of autoencoder based CSI feedback model, for sharing the mapping from communication and computation resource to execution policy

The transmission of the CSI report from the base station 120 on PDCCH can be enhanced with encoded channel information and execution policy (see step 5 of FIG. 5).

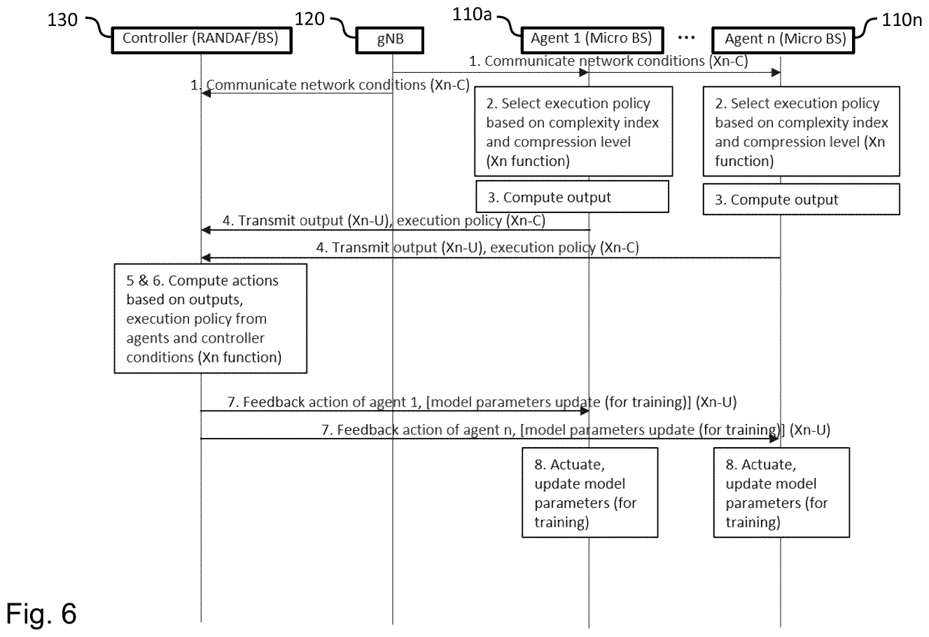

FIG. 6 shows the message exchange for a further embodiment, where the plurality of agent entities are cooperative drones implementing a respective Micro BS for enhancing network coverage, such as for critical V2X applications. In this embodiment, the controller entity 130 is implemented as a RANDAF/BS controller entity 130 and the agent entities 110a-n are implemented as drone Micro BSs 110a-n providing enhanced coverage to network users. The input (sensor) information to each drone agent entity 110a-n may include its location, i.e. its x, y, z coordinates, the direction/angle and transmit power of each antenna used by the drone agent entity 110a-n to cover some area underneath, the number of users supported by each of these antennas, average uplink and downlink traffic load and throughput per antenna, as well as an estimation of coverage area overlap with neighboring drones per antenna. The feedback action by the controller entity 130 may include the next (target) location of the respective drone agent entity 110a-n, as well as the direction, angle, and transmission power of each antenna used by the respective drone agent entity 110a-n.

In a step 1 of FIG. 6, the gNB 120 shares information about the network conditions to the plurality of drone agent entities 110a-n and the controller entity 130, for instance, via the Xn-C interface.

In step 2 of FIG. 6, each drone agent entity 110a-n selects the ML model execution policy based on the complexity level and the compression function, for instance, based on the table shown in FIG. 2.

In step 3 of FIG. 6, each drone agent entity 110a-n determines the output of the ML model in accordance with the execution policy selected in the previous step.

In step 4 of FIG. 6, each drone agent entity 110a-n transmits the output of the ML model as well as the execution policy to the controller entity 130.

In steps 5 and 6 of FIG. 6, the controller entity 130 determines the actions for the drone agent entities 110a-n based on the outputs of the ML models 111a-c and the execution policies from the drone agent entities 110a-n and possibly based on further conditions of the controller entity 130.

In step 7 of FIG. 6, the controller entity 130 feedbacks the actions determined in the previous step to the drone agent entities 110a-n

In step 8 of FIG. 6, each drone agent entity 110a-n may perform an action, such as change its position, and update its ML model parameters based on the actions received from the controller entity 130.

In a further embodiment, the agent entities may be mobile robot agent entities used in a factory to provide sensing and communication capabilities to the machines. The difference to the previous embodiment is that the input information could also include some feedback to the mobile robot, e.g. their actions to be taken, or request for new types of sensing information submitted by the mobile robots. Thus, in addition to what has been described for the previous embodiment, in this embodiment the feedback action from the controller entity may also include a request to the mobile robot agent entity to activate new sensing components or deactivate unused sensing components of the mobile robot agent entity, for instance, for saving energy of the mobile robot agent entity.

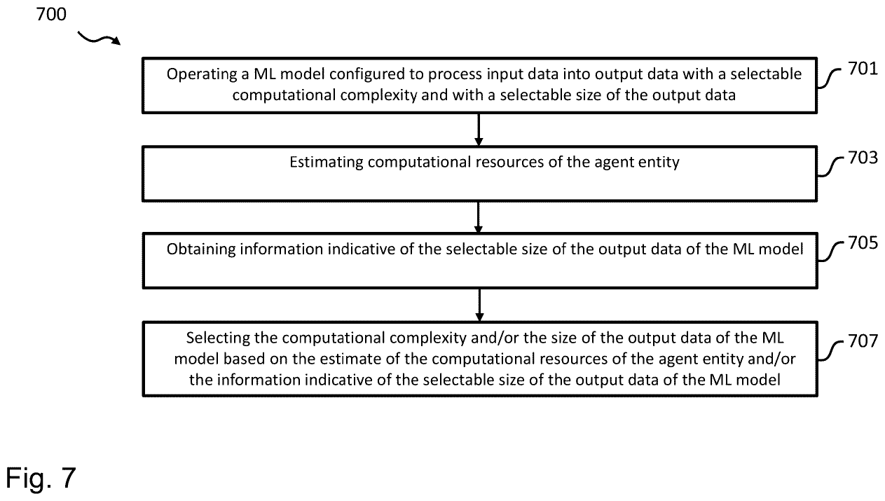

FIG. 7 is a flow diagram illustrating a method 700 for operating an agent entity, such as the UE agent entities 110a-n or the base station agent entity 120, for adaptive learning. The method 700 comprises a step 701 of operating a machine learning, ML, model, such as the ML models 111a-c, wherein the ML model 111a-c is configured to process input data into output data with a selectable computational complexity and with a selectable size of the output data. Moreover, the method 700 comprises a step 703 of estimating computational resources of the agent entity 110a-n; 120 and a step 705 of obtaining information indicative of the selectable size of the output data of the ML model 111a-c. The method 700 further comprises a step 707 of selecting the computational complexity and/or the size of the output data of the ML model 111a-c based on the estimate of the computational resources of the agent entity 110a-n; 120 and/or the information indicative of the selectable size of the output data of the ML model 111a-c.

The method 700 can be performed by each UE agent entity 110a-n or the base station agent entity 120 according to an embodiment. Thus, further features of the method 700 result directly from the functionality of the UE agent entities 110a-n and the base station agent entity 120 as well as the different embodiments thereof described above and below.

As will be appreciated, embodiments disclosed herein allow a dynamic adaptation of the complexity and, for instance, the compression level of a ML model of an agent entity in split learning environments. This allows each agent entity to adapt to a dynamic wireless environment and save memory space for storing the adapted ML models. The efficient selection of CSI compression levels implemented by embodiments disclosed herein, allows dynamically adjusting the data rate of the control channel according to channel conditions and the computational capacities of each agent entity (depending on, for instance, the battery state of the respective agent entity). Moreover, embodiments disclosed herein enable cooperation between robot agent entities in dynamic environments and coordination of coupled BSs, such as macro BS, with micro/femto BSs.

The person skilled in the art will understand that the “blocks” (“units”) of the various figures (method and apparatus) represent or describe functionalities of embodiments of the present disclosure (rather than necessarily individual “units” in hardware or software) and thus describe equally functions or features of apparatus embodiments as well as method embodiments (unit=step).

In the several embodiments provided in the present application, it should be understood that the disclosed system, apparatus, and method may be implemented in other manners. For example, the described embodiment of an apparatus is merely exemplary. For example, the unit division is merely a logical function division and may be another division in an actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the disclosure may be integrated into one processing unit, or each of the units may exist alone physically, or two or more units may be integrated into one unit.

What is claimed is:

1. An agent entity for adaptive learning, the agent entity comprising:
processing circuitry configured to:
operate a machine learning (ML) model, wherein the ML model is configured to process input data into output data with a selectable computational complexity and with a selectable size of the output data;
estimate computational resources of the agent entity;
obtain information indicative of the selectable size of the output data of the ML model; and
select the computational complexity and/or the size of the output data of the ML model based on the estimate of the computational resources of the agent entity and/or the information indicative of the selectable size of the output data of the ML model.

2. The agent entity of claim 1, wherein the processor is configured to receive the information indicative of the selectable size of the output data of the ML model from a controller entity via a wireless communication channel.

3. The agent entity of claim 1, wherein for obtaining the information indicative of the selectable size of the output data of the ML model, the processor is configured to estimate communication resources for communicating via a wireless communication channel with a controller entity, and
wherein the processor is configured to select the computational complexity and/or the size of the output data of the ML model based on the estimate of the computational resources and the estimate of the communication resources.

4. The agent entity of claim 3, wherein for estimating the communication resources, the processor is configured to obtain information indicative of a current data rate for communicating over the wireless communication channel between the agent entity and the controller entity, and
wherein the processor is configured to select the computational complexity and/or the size of the output data of the ML model based on the estimate of the computational resources of the agent entity and the information indicative of the current data rate.

5. The agent entity of claim 2, wherein the processor is further configured to send the output data of the ML model via the wireless communication channel to the controller entity.

6. The agent entity of claim 5, wherein, in response to sending the output data of the ML model to the controller entity, the processor is further configured to receive response data from the controller entity, wherein the response data is based on the output data of the ML model of the agent entity and a plurality of further output data of a plurality of further ML models of a plurality of further agent entities.

7. The agent entity of claim 6, wherein the response data contains information indicative of an action to be taken by the agent entity and/or information for performing a backward pass for updating the ML model.

8. The agent entity of claim 2, wherein the agent entity is a user equipment (UE) configured to exchange data with the controller entity via the wireless communication channel and a base station.

9. The agent entity of claim 8, wherein the ML model is an encoding portion of an autoencoder, wherein the input data of the encoding portion of the autoencoder is channel state information, and wherein the output data of the encoding portion of the autoencoder is compressed channel state information.

10. The agent entity of claim 2, wherein the agent entity is a mobile micro base station of a plurality of mobile micro base stations, and
wherein the output data of each mobile micro base station allows the controller entity to coordinate the plurality of mobile micro base stations.

11. The agent entity of claim 2, wherein the agent entity is a base station, and wherein the controller entity is a user equipment (UE).

12. The agent entity of claim 1, wherein the ML model comprises a plurality of processing layers for processing the input data into the output data, and
wherein for selecting the computational complexity of the ML model the agent entity is configured to select a selectable number of processing layers of the plurality of processing layers of the ML model.

13. The agent entity of claim 1, wherein the agent entity comprises a battery for powering one or more processors of the agent entity for implementing the ML model, and
wherein the agent entity is configured to estimate the computational resources of the agent entity based on a charge status of the battery.

14. A method for operating an agent entity for adaptive learning, the method comprising:
operating a machine learning (ML) model, wherein the ML model is configured to process input data into output data with a selectable computational complexity and with a selectable size of the output data;
estimating computational resources of the agent entity;
obtaining information indicative of the selectable size of the output data of the ML model; and
selecting the computational complexity and/or the size of the output data of the ML model based on the estimate of the computational resources of the agent entity and/or the information indicative of the selectable size of the output data of the ML model.

15. A non-transitory computer readable medium comprising processor-executable code that, when executed by one or more processors, causes the one or more processor to perform a method for operating an agent entity for adaptive learning, the method comprising:
operating a machine learning (ML) model, wherein the ML model is configured to process input data into output data with a selectable computational complexity and with a selectable size of the output data;
estimating computational resources of the agent entity;
obtaining information indicative of the selectable size of the output data of the ML model; and
selecting the computational complexity and/or the size of the output data of the ML model based on the estimate of the computational resources of the agent entity and/or the information indicative of the selectable size of the output data of the ML model.
